(19) United States
(12) Patent Application Publication
(10) Pub. No.: US 2006/0116926 A1
(43) Pub. Date: Jun. 1, 2006

(54) Method and system for internet publishing and advertising forums

(76) Inventor: Michael W. Chen, Diamond Bar, CA (US)

Correspondence Address: MICHAEL W. CHEN, 23610 CHANDELLE PLACE, DIAMOND BAR, CA, 91765, US

(21) Appl. No.: 10/998,784

(22) Filed: Nov. 27, 2004

(51) Int. Cl. G06Q 30/00

(52) U.S. Cl. 705/14

(57) ABSTRACT

The present invention provides a method and system for conducting online publishing and advertising forums that offers two essential benefits to authors, especially independent authors: 1) providing a centralized Internet repository for authors of all backgrounds, proficiencies, expertise and age groups to publish their knowledge, ideas, work, thoughts and opinions on a wide range of topics and subjects; and 2) rewarding authors with a recurrent royalty drawn from the advertising revenue generated specifically by the articles they published. The collectively diverse and rich content of substance offered by these forums can ultimately boost the visibility and readership of individual articles, a goal difficult to achieve if they were published alone using the limited resources of individual authors. The recurrent nature of the royalty is another unique feature of the present invention such that authors may benefit from their publications financially for an extensively long period.

### REFERENCES CITED

U.S. Patent Documents

| | | |
|---|---|---|
| 5,625,818 | April, 1997 | Zarmer, et al. |
| 5,710,883 | January, 1998 | Hong, et al. |
| 5,727,156 | March, 1998 | Herr-Hoyman, et al. |
| 5,768,528 | June, 1998 | Stumm |
| 5,794,207 | August, 1998 | Walker, et al. |
| 5,819,032 | October, 1998 | de Vries, et al. |
| 5,960,411 | September, 1999 | Hartman, et al. |
| 6,618,751 | September, 2003 | Challenger, et al. |
| 6,789,228 | September, 2004 | Merril, et al. |

Other References
Price Water House Cooper, “IAB Internet Advertising Revenue Report,” September, 2004, Interactive Advertising Bureau, http://www.iab.net/resources/adrevenue/pdf/IAB_PwC %202004Q2.pdf.
Price Water House Cooper, “IAB Internet Advertising Revenue Report,” April, 2004, Interactive Advertising Bureau, http://www.iab.net/resources/adrevenue/pdf/IAB_PwC_{—}2003.pdf.

### TECHNICAL FIELD

The present invention relates to computer online publishing and advertising and the required method and system for offering services to authors, readers and advertisers on the Internet.

### BACKGROUND OF THE INVENTION

The Internet began as links between local area networks of computers of multiple academic campuses for exchanging documents and electronic-mail. One method of document exchange is creating documents in the Hyper-Text Markup Language (HTML) format and placing them on a computer called the Web server. A Web server is capable of presenting documents at a virtual Internet location, also known as a Web site, and delivering them to a large number of client computers on the Internet using the Hyper-Text Transfer Protocol (HTTP). HTML greatly contributed to the explosive growth of the Internet with the ability to include graphics and multi-media elements and cross document cross Web site links or hyper-links, thus joining all connected documents and Web sites into a virtual Web of information. Client computers are equipped with a piece of software called the Web browser that can navigate the Web, download, interpret and reproduce HTML documents on the client computer screen for the user to view.

The global expansion of the Internet has presented many businesses with new opportunities. Traditional publishers like newspapers and magazines naturally extended their reach on the Internet by publishing their articles and columns simultaneously online and on print or exclusively online more often than ever, hence the term online publishing. Corporations, particularly those in the technology sector, are also quick to publish large volumes of technical and business information on the Internet to promote their products and to assist their partners, customers, developers and IT specialists. Furthermore, online publishing is not reserved to a small group of elite writers and authors employed by or contribute to large publishers and organizations. Small commercial and civil entities are able to create their Web presents with relative ease to promote their businesses or causes. Individual Internet users from all walks of life can also write and publish their own multi-media Web content on personal Web sites hosted by their Internet service providers. Online public forums such as news-groups and chat rooms are also popular venues for people to offer their opinions and share their knowledge with fellow participants and the Internet community.

We can divide authors publishing online into two simple categories, affiliated authors and non-affiliated or independent authors. Affiliated authors are those who publish their work on the Web sites of certain business and civil entities, namely the staff and contributing writers of these entities. Independent authors are those who publish personal work, thoughts, opinions, ideas and knowledge not related to any organizations. Affiliated authors usually need not be concerned about whether their published work will have sufficient Internet exposure and readership, because these publications have the full advantage of the Web infrastructure of their organizations, particularly the notoriety, overall quality and richness of their hosting Web sites and the supports of professional IT staffs.

On the other hand, even though it is technically easy for independent authors to publish online, it is not so easy for their work to reach a wide audience for several reasons. Information on the Internet as a whole is inherently unorganized and spread among a vast number of Web sites and Web pages, resulting in a great deal of Web content, especially those published by independent authors, being buried in obscurity. Also, individuals often lack the expertise and resources to improve the overall appeal of the Web sites on which they publish and to increase the visibility of their work through online search and directory services such as Google™ and Yahoo!®. It is interesting to note that affiliated authors will become independent authors themselves when they write outside the confines of their affiliation. Then immediately they too face the same obstacles of all independent authors, because the resources of their employers are no longer at their disposal. Finally, the prevailing public perception of information available on the Internet is that it is free. Therefore, it is not surprising that independent authors almost never benefit financially from their work published online. While popular commercial Web sites with rich content and quality services are able to attract most of the billions of dollars of Internet advertising revenues each year, it would seem farfetched for independent authors to do the same with their limited content and Web visibility.

The business arrangement between a traditional publisher and an author is that the publisher pays the author a royalty when the initial and subsequent editions of the publication go to press. It is a reasonable arrangement given the characteristics of printed materials such as limited publication copies, limited readership and limited life span of paper. In contrast, the Internet is a superior publishing medium free of many of the limitations of printed media: 1) each time a reader views a Web page, a verbatim copy of the page is reproduced on the reader's computer screen; 2) a Web page may have unlimited life-span as long as it remains on a Web site; 3) the cost of maintaining Web pages is minimal compared to producing and preserving physical copies of a traditional publication; 4) the potential readership of a Web page may be unlimited given the vast and growing number of Internet users. However, there is currently no system or service on the Internet that can reward authors financially in a way that is proportional to all the advantages publishers gained by publishing online. Publishers are still following the traditional practice of paying a contributing author a one-time royalty when the contributed article goes online. On the other hand, a popular article on a Web site can almost indefinitely attract unlimited number of Internet readers and continuously generate business and advertising revenues.

### SUMMARY OF THE INVENTION

The present invention provides a method and system for creating and operating Internet-based publishing and advertising forums that service three groups of people and entities: authors, readers and advertisers. These forums allow authors of all backgrounds, proficiencies, expertise and age groups to publish their work, knowledge and opinions on a wide range of topics and subjects. These forums exist on the Internet as public Web sites that allow free access to all Internet users (or readers). The collectively diverse and rich content of substance on these Web sites can attract a much greater number of readers than any individual article published alone. Further, authors can benefit financially from a recurrent royalty drawn from the advertising revenue generated specifically by the articles they published. In one embodiment of this invention, readers can browse and drill down to articles organized based on their subject matters in a multi-layer catalog, or be redirected to an article from a keyword search offered by search engines internal or external to the forum. Articles are presented to readers along with ads and hyper-links to Web sites or online shopping channels of the advertisers. Advertisers can reach audiences of specific demographics or interests by placing their ads in articles of certain categories and topics or with specific keywords related to their product offerings. Applicable pricing models for ads include: impression based (cost-per-thousand impressions, or CPM), performance based (cost-per-click, or CPC) and the hybrid of both. For example, when a reader is interested in a CPC ad and clicks on its hyper-link, the system records this reader action (user click) and the association of the ad, article, author and advertiser. Then the system redirects the Web browser of the reader to the advertiser's Web site. For a CPM ad, each time the ad is displayed in an article the system records the association of the article viewed by the reader and the ad shown. At the end of each accounting cycle, reports are generated using the total occurrences of user clicks and ad impressions of that period to calculate the total ad cost for the advertisers and the royalty due to each author whose articles led to the user clicks or ad impressions. In another embodiment, ads shown with articles are dynamically inserted by third party online advertising agents. These agents are capable of collecting ad performance data independently, billing the advertisers and periodically paying the ad revenue due to the forum. The forum also receives ad performance reports from ad agents, which include the user click and ad impression data of that period. The forum system can then calculate the appropriate royalty amount and pay the corresponding authors based on the user click and ad impression data in those ad reports.

### BRIEF DESCRIPTION OF DRAWINGS

FIGS. 1 to 8 are flowcharts illustrating one embodiment of the present invention.

FIG. 1 illustrates an author registering and receiving an author ID generated by the system.

FIG. 2 illustrates an author submitting an article for publication.

FIG. 3 illustrates an advertiser registering and receiving an advertiser ID generated by the system.

FIG. 4 illustrates an advertiser submitting an ad with ad insertion preferences.

FIG. 5A-5C illustrates three Web pages of the forum Web site.

FIG. 6 illustrates an Internet user finding and reading an article with ads paid on a per-impression basis.

FIG. 7 illustrates an Internet user finding and reading an article with ads paid on a per-user-click basis.

FIG. 8 illustrates the accounting process of paying the authors and billing the advertiser.

FIGS. 9 to 11 are flowcharts illustrating portions of the second embodiment that differs from the first in which ads are inserted into articles at run-time by a third party advertising agent system.

FIG. 9 illustrates registering and receiving an ad channel for an author from an ad agent system.

FIG. 10 illustrates an Internet user finding and reading an article with ads paid on a per-click basis.

FIG. 11 illustrates the accounting process of paying the authors.

### DETAILED DESCRIPTION OF THE INVENTION

The present invention provides a method and system for conducting online publishing and advertising forums that offers two essential benefits to authors, especially independent authors: 1) providing a centralized Internet repository for authors of all backgrounds, proficiencies, expertise and age groups to publish their knowledge, ideas, work, thoughts and opinions on a wide range of topics and subjects; and 2) rewarding authors with a recurrent royalty drawn from the advertising revenue generated specifically by the articles they published. The collectively diverse and rich content of substance offered by these forums can ultimately boost the visibility and readership of individual articles, a goal difficult to achieve if they were published alone using the limited resources of individual authors. The recurrent nature of the royalty is another unique feature of the present invention such that authors may benefit from their publications financially for an extensively long period.

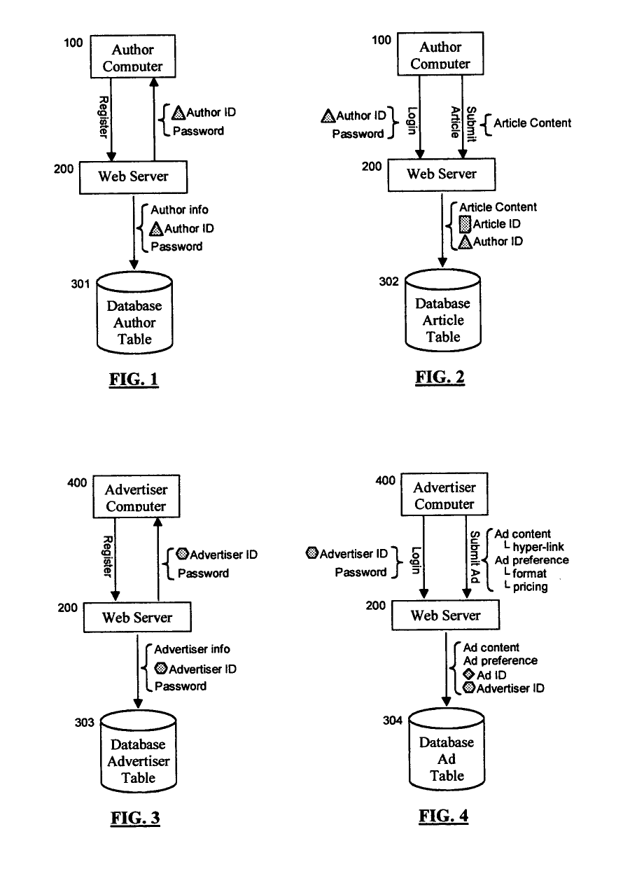

Two preferred embodiments of the present invention are discussed here with reference to FIGS. 1 to 11. Although many specifics are presented in the following descriptions, they are for the purpose of thorough illustration of the embodiments and do not impose limitations on the invention. At the same time, some details are left out of the drawings and descriptions, because they are well known techniques in the art. One skilled in the art may device alternate embodiments with variations in details but would appreciate that such alternatives fall within the scope of the present invention. For inspiration and support in bringing the present invention to practice, the inventor acknowledges Alex H. Huang and Tony X. Liu.

### Embodiment One

The first preferred embodiment of the present invention consists of seven inter-related processes: author registration, article submission, advertiser registration, ad submission, Web presentation, article delivery, and accounting. Data input and exchanged among these processes is stored in and retrieved from a database system. This embodiment uses a relational database management system, in which a set of related data is store in a tabular structure (or table) with a fixed number of columns and a plurality of rows. The term identifier or ID, also known as key, refers to a unique piece of data used to unambiguously identify another piece or group of data such as a specific row in a table. A table often contains at least one column of identifiers, so the row in which the identifier resides or individual column values of that row can be retrieved by matching the identifier to the one supplied. The storing and retrieving of data presented here all involve the use of identifiers, and the name of the identifier implies its subject.

1. Author Registration

The author registration process collects and stores contact and billing information from new authors. FIG. 1 depicts one author registering using a computer (100). The interface is a Web page form that can be filled out using a Web browser and submitted to the forum Web server (200). The Web page form may offer the author the choice of selecting an Author ID of his own or receiving one generated by the forum. The interface also accepts a password from the author for future access to the forum using the Author ID and this password. Upon receiving the submitted data, if the author entered an Author ID, the system verifies its uniqueness against all Author IDs of previously registered authors in the database. If the entered Author ID is already used, the Web server notifies the author to pick a different one and submit the registration form again. If the Author ID is unique, or in the case the author accepts an automatically generated one, the system saves the author information, Author ID and password into an Author Table in the database (301) and returns a Web page of confirmation to the author with the Author ID and password. To protect all sensitive information exchanged online, this process is conducted using a secure Web server that supports the HTTPS protocol.

2. Article Submission

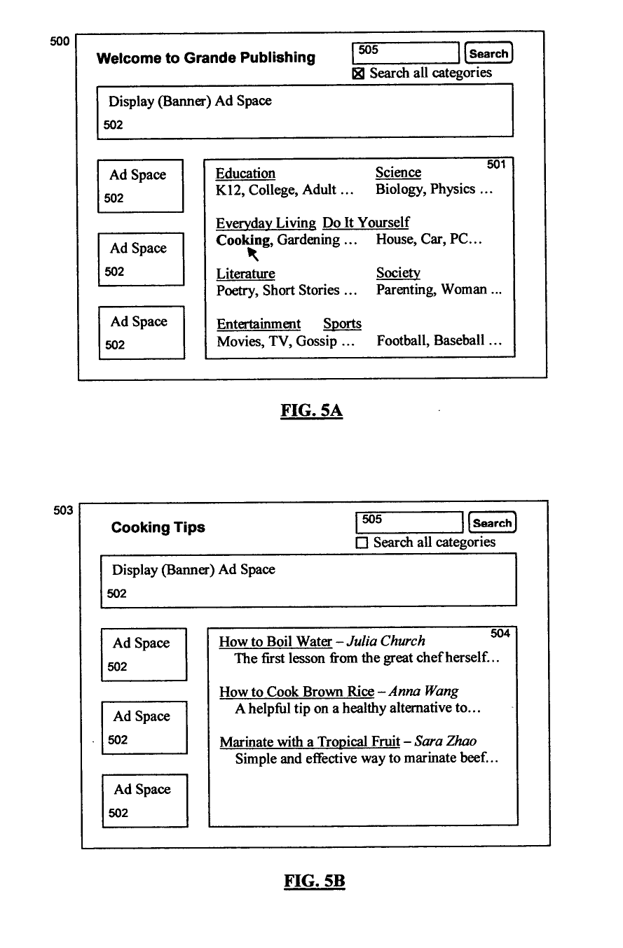

The article submission process is depicted in FIG. 2. The process begins with the log-in of the author from a computer (100) using the Author ID and password to a secure Web server (200) that supports the HTTPS protocol. After a successful login, the author can upload the article in the preferred plain text or HTML format. Other word processing formats are allowed provided that the corresponding conversion programs are in place. An online HTML editor is also available for authors to enter and edit short articles. The author can also indicate the desired category or suggest a new category in which their article should reside. After the article is uploaded, an automated censorship program will scan the article to determine if its contents meet the standards imposed by the forum. Additional human editors may be needed to further safe-guard these standards. Authors will be notified later by email whether their articles are accepted, edited or rejected. If an article is accepted, a new unique Article ID is generated and saved into an Article Table in the database (302) along with the article content, title, abstract, designated category name, and finally the Author ID. A trivial variation can be implemented here such that the article content is saved as a file in the computer file system, and its file name is stored in the Article Table instead. To take advantage of the positive identification of the author, this process can also include supporting features such as submitting revisions to previous articles, retracting articles, changing password, billing and email address and viewing past and current royalty payments.

3. Advertiser Registration

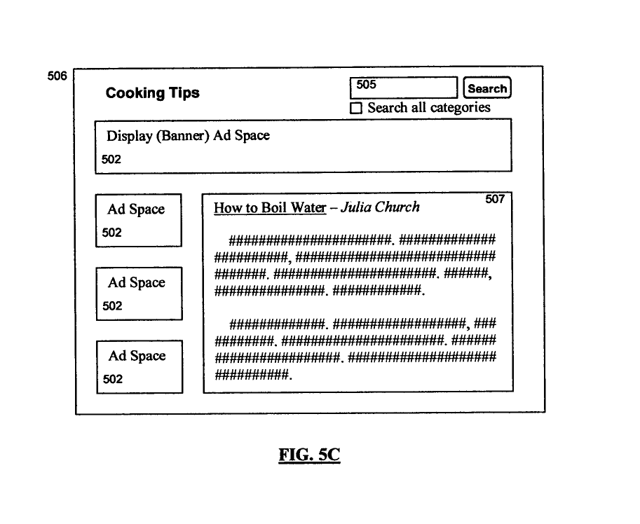

The advertiser registration process collects and stores contact and billing information of new advertisers. FIG. 3 depicts one advertiser registering using a computer (400). The interface is a Web page form that can be filled out using a Web browser and submitted to the forum Web server (200). Upon receiving the data, the Web server system generates a new unique Advertiser ID and a random password. Then the system saves the advertiser's information, Advertiser ID and password into an Advertiser Table in the database (303) and returns a Web page of confirmation including the Advertiser ID and password to the advertiser. To protect all sensitive information exchanged online, this process is conducted using a secure Web server that supports the HTTPS protocol.

4. Ad Submission

The ad submission process is depicted in FIG. 4. The process begins with the log-in of the advertiser from a computer (400) using the Advertiser ID and password to a secure Web sever (200) that supports the HTTPS protocol. After a successful login, the advertiser can fill in and submit the ad content and ad preference in a Web page form interface. Ad content may contain a hyper-link to the advertiser's Web site or shopping channel. Ad preference includes the preferred advertising format and pricing model. There are three applicable ad formats: display ad, search listing and contextual search, and there are three applicable pricing models: cost-per-thousand impressions (CPM), cost-per-click (CPC) and the hybrid of both. A display ad, also called banner ad, is an ad consistently displayed in a Web page each time the page is viewed by an Internet user (count as one impression). The advertiser usually pays a CPM fee for a display ad. Search listings are ads shown at the top or side of a result page returned from an Internet search service. The search service selects what ads to show based on the keywords searched by the Internet user. Contextual search are ads inserted in an article based on the article context. The majority of both search based ads use the CPC pricing model such that the advertiser only pays a CPC fee when the user clicks on the hyper-link embedded in the ad pointing to the advertiser's Web site. However, all three pricing models are applicable to all three ad formats discussed here. For example, a display ad can also use the CPC pricing model so that the advertiser pays for both ad impressions and user clicks.

Upon receiving the ad submission, the Web server system generates a new unique Ad ID for this ad and stores the ad content, ad preference and Ad ID into an Ad Table in the database (304). The Ad Table also contains a column for ad hyper-links. If an ad is submitted with a CPC or hybrid pricing model, the hyper-link embedded in the ad content is removed and stored in the hyper-link column of the same row as the ad content. This step is needed in the article delivery process. Finally, this process can also provide maintenance features like modifying previously submitted ad content and preference, changing billing and contact information and login password of the advertiser.

5. Web Presentation

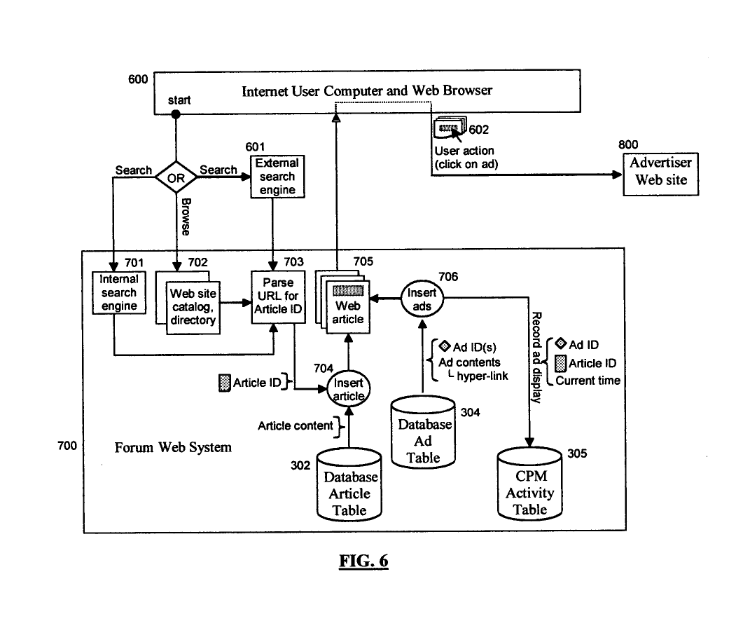

The Web presentation process creates the look and feel of the forum Web site. In this embodiment of the invention, articles are organized into base categories according to their subject matters. Base categories are further grouped into upper and major categories. FIG. 5A illustrates the home page (500) of the Web site which shows the main category (501). Ad spaces (502) are reserved on the Web pages of all categories so that advertisers may elect to place their ads in specific categories based on their assessments of the potential readership and interest in relation to their product offerings. Items in the main category are grouped into major categories (e.g. Education, Science, Everyday Living, etc.) Under each major category are names of sub-categories or base categories. Clicking on the name of a major category or sub-category will open the corresponding category Web page with the similar structure. Clicking on the name of a base category, for example Cooking, will open a base category Web page. FIG. 5B illustrates a base category page (503) constructed similar to other category pages except that the main content area contains a list of articles (504). Each item in the list shows the title of the article, the author's name, and an abstract or excerpt of the article. The title contains a hyper-link to the full content of the article, and the Article ID is embedded in the hyper-link as a URL parameter. This must be the consistent format for all hyper-links on the Web site referring to articles so that external search engines can also refer to articles in search results using the identical hyper-link that includes the Article ID. If an Internet user clicks on the hyper-link to an article, the forum Web server will use the article delivery process to return an article page. FIG. 5C illustrates an article page. The layout of an article page (506) is almost identical to a base category page except that the main content area contains the full article content (507). Unlike category pages, ads inserted in an article page are associated with the article and the author of the article. The article delivery process uses this association to track ad revenue and calculate royalty due to the author.

An input box (505) and a “Search” button is place in every Web page for readers to search articles on the forum based on keywords. A check box captioned “Search all categories” is place under the input box, which determines whether the search is limited to the current category and its sub-categories or among all categories. The search result is returned in a Web page in the same format as the base category page with a list of matching articles. The forum system can insert search based ads in the search result page. The mechanism to determine what ads to appear in a keyword search result is beyond the scope of the present invention.

6. Article Delivery

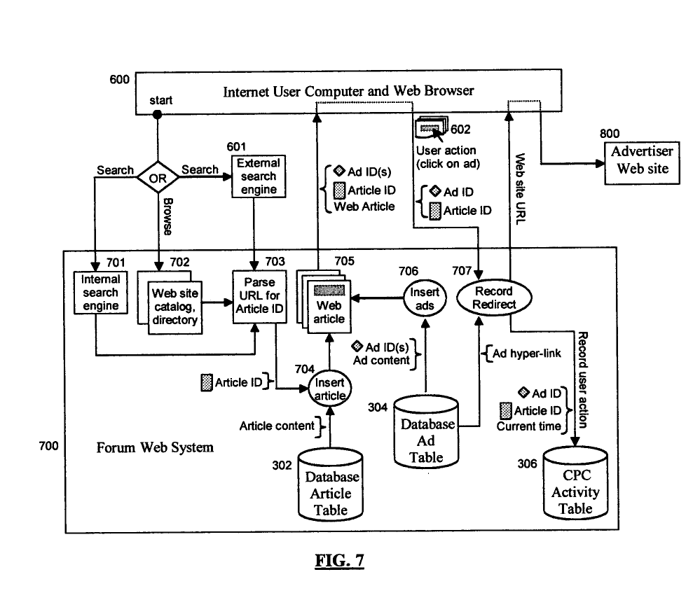

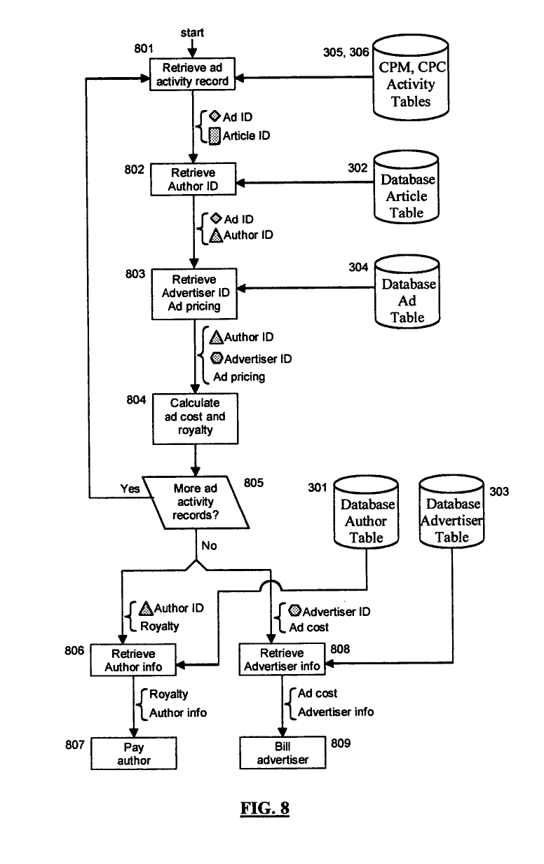

Two variations of the article delivery process are presented here. FIG. 6 illustrates one that delivers articles with display ads that use the CPM pricing model. FIG. 7 shows one for cost-per-click type ads. These two variants usually coexist such that the same article Web page may contains both types of ads. The article delivery process starts with a reader using a computer and a Web browser program (600) to locate an article available on the forum system (700) via the Internet. There are a number of paths the user can take to find an article. The user may visit the forum Web site and browse through the main category, subcategories and base categories (702) for available articles (see also FIG. 5A-5B.) Each item in the base category represents one article and includes the article title, author, abstract and an embedded hyper-link to the full article content. The user can also use either the built-in search engine (701) of the forum Web site or an external search engine (601) to perform a keyword search. If an article matches the criteria, the search result will include a hyper-link to that article on the forum. The user can also access the article directly (not shown in FIGS. 6 and 7) via a typed-in or previously saved hyper-link (bookmark) to the article. In all cases, clicking on, typing in or recalling a hyper-link causes the user's Web browser to send an HTTP request to the forum Web server to retrieve the full content of the article.

Upon receiving the HTTP request, the Web server parses (703) the request URL to extract the Article ID. Then the Article ID is used to retrieve the corresponding article content from the Article Table of the database (302). If the Article ID is not found in the database, the system returns the appropriate HTTP error reply. If the article content is successfully retrieved, the system inserts (704) the article content into a persistent HTML document template. The combined HTML document is called the Web article (705) with reserved ad spaces on the top and on the left side of the Web page. The screen layout of the Web article is illustrated in FIG. 5C. The article content is inserted in the main content area of the template (507).

Next, the system qualifies ads for the article. Display ads are always qualified for all articles. If the current article request came from a search listing, most search services include the keyword(s) searched by the user in a HTTP header or in the URL. Then a search based ad is qualified if the ad preference also specifies the same keyword(s). If the current request came from browsing the base category, typed-in or recalled hyper-links, then a separate qualifying routine is run to search the content of the article for keyword(s) specified in the ad preference of all search based ads. Ads placed this way are called contextual search ads. The detail of this qualifying routine is beyond the scope of this invention.

After collecting the complete set of qualified ads, the system determines what ads to insert into the ad spaces. There are always limited ad spaces in a page, and a space closer to the upper left hand corner of the page is more favorable than the rest. When multiple ads are qualified, the ad with the highest price is selected for the most favorable ad space remained until all spaces are filled. Since the price of a CPM based ad cannot be compared to that of a CPC ad, the system must divide the ad spaces among the two pricing models. Hybrid pricing model ads can compete in both groups. There are two variants for the remainder of the article delivery process depending on the pricing model (CPM or CPC) of the selected ad. Both variants are applied simultaneously on ads in different ad spaces. A hybrid model ad is considered a special case of the CPC model ad.

FIG. 6 illustrates the process for an ad with a CPM pricing model. The system uses the Ad ID of the selected ad to retrieve the ad content from the Ad Table (304) then inserts the ad content (706) into the ad space. Since the ad submission process left this type of ad content intact, the ad content may also include the hyper-link to advertiser's Web site. Then the system records the current time and one instance of the Ad ID and Article ID pair into a CPM activity table (305) in the database. Unlike other tables in the database, this table serves as a log and allows multiple occurrences of the same ID. Optionally, a CPM log file can be used instead of a database table such that each line of the log file contains the current time, the Ad ID and the Article ID. After all ad spaces are filled, the system transmits the Web article to the Internet user's Web browser. While reading the article, if the user is interested in the CPM ad inserted here and clicks on its hyper-link (602), the user browser will access the advertiser's Web site (800) directly.

FIG. 7 illustrates the process for a CPC or hybrid pricing model ad. The system uses the Ad ID of the selected ad to retrieve the ad content from the Ad Table (304). Note that the ad hyper-link embedded in the ad content was removed in the ad submission process for CPC or hybrid ads. Next, the system embeds in the ad content a hyper-link that points back to a record and redirect routine on the forum Web server. This hyper-link contains the Article ID and Ad ID as its URL parameters. Then the system inserts (706) the ad content into the ad space. If this is a hybrid pricing model ad, the system also perform the extra step of recording the current time and one instance of the Article ID and Ad ID pair into the CPM activity table of the database (305 of FIG. 6). After all ad spaces are filled, the system transmits the Web article to the Internet user's Web browser. Upon receiving and reading the Web article, if the user is interested in a CPC or hybrid ad inserted here and clicks on the hyper-link (602), the user's Web browser sends another request to the record and redirect routine (707) in the forum Web server. The record and redirect routine first parse the request URL to extract the Article ID and Ad ID. Then record the current time and one instance of the Article ID and Ad ID pair into a CPC activity table in the database (306) or optionally a CPC log file. The routine then uses the Ad ID to retrieve the ad hyper-link from the Ad Table (304) stored in the ad submission process and sends an HTTP redirect reply back to the Internet user's Web browser with the advertiser's Web site URL. After receiving the redirect reply, the Web browser will access the advertiser's Web site (800) directly.

7. Accounting

The accounting process, depicted in FIG. 8, is performed in a regular interval. The process calculates the total ad cost for each advertiser and the royalty for each author using the recorded Article ID and Ad ID pairs in both the CPM and CPC activity table (305, 306) and the corresponding ad pricing. The routine for the calculation consists of the following steps:

(a) Assign zero to the royalty amount for each author. The royalty amount can be a column in the Author Table or a variable in the computer memory, and in both cases the royalty amount for an author is identified by the Author ID.

(b) Assign zero to the total ad cost amount for each advertiser. Similarly, the ad cost amount can be a column in the Advertiser Table or a computer memory variable and is identified by the Advertiser ID.

(c) Retrieve one ad activity record (801) stored as an Article ID and Ad ID pair in the CPM activity table of the database (305). Use the recorded time to ensure it falls within the current accounting period.

(d) Use the Article ID to retrieve the Author ID (802) from the Article Table of the database (302). This relation was established in the article submission process when the article content and these two IDs were saved together.

(e) Use the Ad ID to retrieve the Advertiser ID and the CPM price (803) for this ad from the Ad Table of the database (304). This relation was established in the ad submission process when the ad content, ad preference and these two IDs were saved together. The CPM price used here is the unit price of a single impression instead of the price of one thousand impressions.

(f) Use the Advertiser ID to find the corresponding ad cost amount. Then add the CPM price to that ad cost amount (804).

(g) Use the Author ID to find the corresponding royalty amount. Then multiply the CPM price by the royalty rate and add the product into the royalty amount (804). The royalty rate is a pre-determined rate representing the revenue sharing relation between the forum and authors.

(h) If more ad activity records exist in the CPM activity table (805), repeat steps (c) to (h) for the next pair of Article ID and Ad ID. Otherwise, repeat steps (c) to (h) using the CPC activity table (306) as the source of the Article ID and Ad ID pairs in step (c), and in step (e) to (g) retrieve and use the CPC price instead.

(i) For each non-zero royalty amount, use the associated Author ID to retrieve the billing information of the author (806) from the Author Table (301) and pay the royalty amount (807).

(j) For each non-zero ad cost amount, use the associated Advertiser ID to retrieve the billing information of the advertiser (808) from the Advertiser Table (303) and bill the ad cost amount (809). This concludes the accounting process for the current period, and it will be repeated when the next accounting cycle ends.

### Embodiment Two

The second preferred embodiment of the present invention consists of six inter-related processes: author registration, article submission, ad channel registration, Web presentation, article delivery, and accounting. The author registration, article submission and Web presentation processes are identical to the ones defined in embodiment one. The primary difference between the first and second embodiment is how ads are inserted into the Web article. In the first embodiment, ads are submitted to the forum beforehand then inserted by the forum Web server system when the article is accessed by Internet users. In this second embodiment, ads are dynamically inserted by third party advertising agents when the Web page containing the article and reserved ad spaces are viewed by the Internet user in a Web browser. The forum neither accepts ads from advertisers, nor does it know what ads are shown with the article. The ad agent is also responsible of collecting ad performance data such as user clicks, calculating ad cost, billing advertisers, paying the forum ad revenue and forwarding the ad performance data. Although presented here separately, it is possible for one skill in the art to integrate this second embodiment with the first so that both methods of ad insertion are supported by one forum and in the same article.

Ad Channel Registration

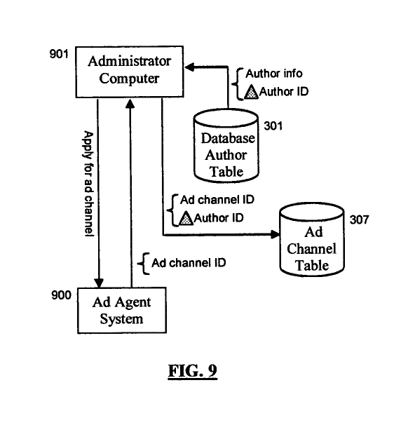

The ad channel registration process, depicted in FIG. 9, is performed by a forum administrator using a computer (901). The process starts with retrieving the Author ID and author information of a newly registered author from the Author Table of the database (301). Then visit the third party advertiser Web site (900) and apply for an ad channel. An ad channel is a single billing unit for ad revenue. In this embodiment, each author has his or her own ad channel. Ads in multiple articles by the same author refer to the same ad channel, so revenues generated by these articles are combined for the same author. Upon accepting the application, the ad agent system creates and returns an ad channel. The returned ad channel, usually a number, is a unique piece of data and can be used directly as the Ad Channel ID. However, if the forum deals with more than one ad agent of this nature, a prefix designated for each ad agent is added to the returned ad channel to form the Ad Channel ID. Finally, the Ad Channel ID and the Author ID are saved into an Ad Channel Table in the database (307).

Article Delivery

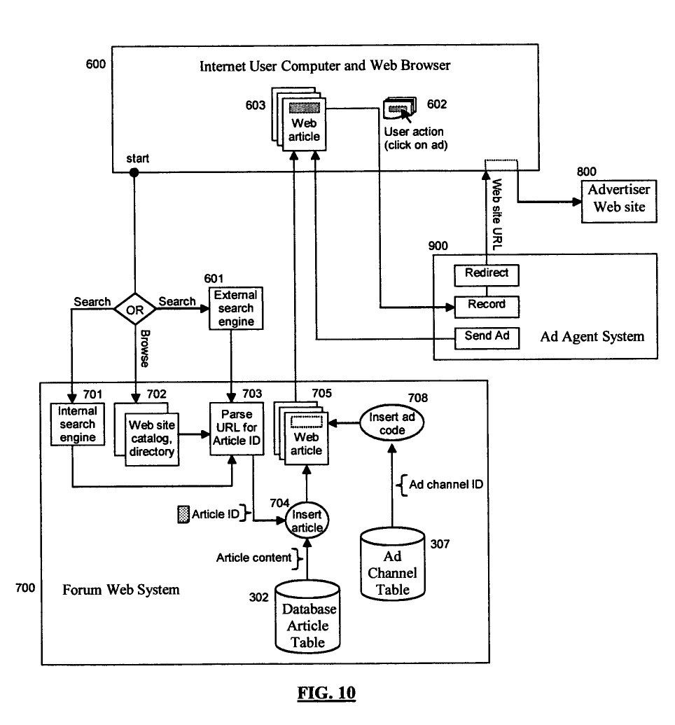

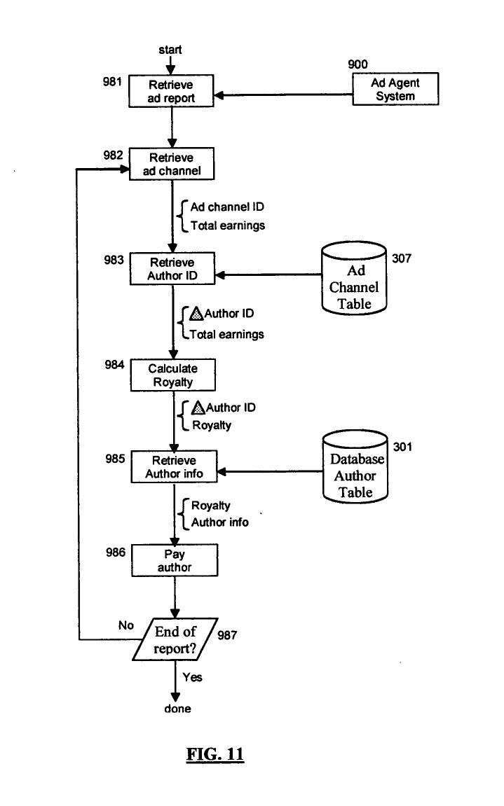

The article delivery process, depicted in FIG. 10, starts with an Internet user using a computer (600) to locate an article on the forum (700) through a number of ways: (a) browse the forum Web site (702) and click on an article hyper-link in the base category; (b) search for keywords using search engines, internal (701) or external (601) to the forum, then click on a hyper-link in the search result pointing to an article on the forum matching the search criteria; (c) type in or recall a saved hyper-link to an article on the forum directly in the Web browser (not shown FIG. 10). In all cases, the user's Web browser sends out an HTTP request to the forum Web server to retrieve the full content of the article. Upon receiving such a request, the Web server extracts the Article ID from the request URL (703) then use the Article ID to retrieve the article content from the Article Table of the database (302). The system then inserts the article content (704) into a HTML document template to form the Web article (705) with reserved ad spaces. Up to this point, the article delivery process of this embodiment is identical to that of embodiment one.

Next, the system uses the Article ID to retrieve the Author ID from the Article Table then uses the Author ID to retrieve the Ad Channel ID from the Ad Channel Table in the database (307). The system then inserts into the ad space a piece of HTML code (708) according to the requirements of the third party advertising agent. One of the elements specified in this piece of HTML code is the Ad Channel ID. All ad spaces reserved for the same ad agent in an article use the same Ad Channel ID. If the Ad Channel ID contains a prefix designated for the ad agent added in the ad channel registration process, the prefix is removed before the Ad Channel ID is applied to the HTML code. If the ad spaces are divided to accept ads from multiple ad agents, the process remains the same except that the HTML code and the Ad Channel IDs differ among different ad agents. Nevertheless, all Ad Channel IDs correspond to the same Author ID.

After the ad agent HTML code is inserted into all ad spaces, the system transmits the Web article to the Internet user's Web browser. When the Web browser displays the Web article (603) on the user's computer screen and encounters the ad agent HTML code in the ad space, the HTML code directs the browser to fetch additional ad content from the ad agent's Web server system (900) to merge with the Web article. Most ads of this nature use the CPC pricing model, in which case the ad content sent by the ad agent system contains a hyper-link back to the ad agent system. If the user is interested in the ad and clicks on this hyper-link (602), the Web browser sends a request back to the ad agent system. The ad agent system in turn records the event for the purpose of tracking and calculating ad revenue for this ad channel. Then the agent system sends an HTTP redirect reply back to the Internet user's browser with a URL to the advertiser's Web site. Upon receiving the reply, the user's Web browser will visit the advertiser's Web site (800). The ad agent system may also support ads with a CPM or hybrid pricing model, in which case the ad agent system records the event (one ad impression) when the ad content is send to the user's Web browser to fill the ad space. For a CPM ad, the ad content contains the hyper-link to the advertiser's Web site instead of one pointing back to the ad agent system. When this hyper-link is clicked by the user, the user's browser will visit the advertiser's Web site directly.

Accounting

The accounting process, depicted in FIG. 11, is performed in a regular interval and may coincide with the accounting cycle of the ad agent. The process begins with receiving the ad performance report (981) from the ad agent system (900) for the current accounting period. The report details the total earnings of each ad channel registered by the forum. If only one ad agent is involved, the ad channel from the ad agent is the Ad Channel ID in the forum system. Otherwise, the prefix designated for the ad agent is added to form the Ad Channel ID. The routine for completing the accounting process consist of the following steps:

(a) Retrieve the first ad channel and the corresponding total earnings for the current period from the ad report then convert the ad channel to Ad Channel ID (982).

(b) Use the Ad Channel ID to retrieve the Author ID (983) from the Ad Channel Table of the database (307). This relation was established in the Ad Channel Registration process.

(c) Calculate the royalty amount (984) by multiplying the total earnings of the ad channel by the royalty rate. The royalty rate is a predetermined rate representing the revenue sharing relation between the forum and authors.

(d) Use the Author ID to retrieve the billing information of the author (985) from the Author Table of the database (301) and pay the royalty amount (986).

(e) Repeat steps (a) to (e) for the next ad channel in the ad report until all channels are processed. This concludes the accounting process for the current period, and it will be repeated when the next accounting cycle ends.

### CONCLUSION

In online publishing, the primary obstacle and disadvantage independent authors face are the difficulty to increase readership and not being rewarded financially from the work they publish. The two embodiments of the present invention described above solve both problems by: (1) harnessing the collective intellectual power of a plurality of authors to build an Internet forum with rich and diverse content to attract a much larger audience; and (2) rewarding authors with a recurrent royalty tied to the advertising revenue their publications contribute.

I claim:

1. A method for conducting Internet-based online publishing and advertising forums in which authors are rewarded with a recurrent royalty drawn from the advertising revenue generated specifically by the articles they published comprising:
(a) an author registration process of inputting the contact and billing information of an author and a new unique author identifier into to an author database, and repeating the same for other authors not previously registered;
(b) an article submission process of inputting the full content of an article, a new unique article identifier and the corresponding author identifier into to an article database, and repeating the same for other articles by the same or different registered author;
(c) an advertiser registration process of inputting the contact and billing information of an advertiser and a new unique advertiser identifier into to an advertiser database, and repeating the same for other advertisers not previously registered;
(d) an ad submission process of inputting the content and preference of an ad, a new unique ad identifier and the corresponding advertiser identifier into to an ad database, and repeating the same for other ads from the same or different registered advertiser;
(e) a Web presentation process of displaying the information of and hyper-links to all available articles on an Internet Web site organized based on the subject matters of the articles, thus allowing Internet users to browse through and drill down to different categories and groups of articles and ultimately click on the hyper-link to an article to view its full content;
(f) an article delivery process of, upon the forum Web server receiving an HTTP request sent by the Web browser of an Internet user to access the full content of an available article, delivering a Web version of the article that includes ads inserted based on their corresponding ad preferences;
(g) an accounting process of periodically paying authors whose articles contributed to the ad revenue of that period, and billing the advertisers for ads performed according to their preferences in that period.

2. The method of claim 1, wherein the ad content of (d) includes a hyper-link to the Web site or shopping channel of the advertiser.

3. The method of claim 1, wherein the ad preference of (d) includes a preferred ad format of either display ad or keyword search ad or contextual search ad, and the corresponding ad pricing of either a unit price paid for per ad impression or a unit price paid for per user click on the hyper-link of the ad.

4. The method of claim 2, wherein the hyper-link for an ad paid on a per user click basis is removed from the ad content and stored in the ad database in the same data record as the ad content such that it can be later retrieved using the ad identifier.

5. The method of claim 1, wherein (e) the hyper-link to an article includes the article identifier as a hyper-link URL parameter.

6. The method of claim 1, wherein (e) further comprises of providing a search engine function on the Web site to allow Internet users to search among all articles available on the forum for certain keyword(s), and displaying in a list the information of and hyper-links to the articles matching the search criteria.

7. The method of claim 6, wherein the hyper-link to an article matching the search criteria includes the article identifier as a hyper-link URL parameter.

8. The method of claim 1, wherein (f) comprises the steps of:
parsing the URL of the HTTP request for the article to extract the article identifier;
using the article identifier to extract the article content from the article database;
inserting the article content into a HTML Web article template with reserved ad spaces;
selecting the appropriate ads to be inserted into the ad spaces based on the corresponding ad preferences;
extracting the ad content, ad pricing and ad identifier of selected ads from the ad database;
for ads paid on a per impression basis, inserting the ad content into the ad space, and recording into an ad activity log the current time and one instance of the ad identifier and article identifier pair; or
for ads paid on a per user click basis, combining and inserting into the ad space the ad content and a hyper-link pointing back to a record and redirect routine in the forum Web server with the ad identifier and article identifier as the hyper-link URL parameters;
transmitting the completed HTML Web article with inserted ads to the Web browser of the Internet user.

9. The method in claim 8, wherein the record and redirect routine for ads paid on a per user click basis comprises the steps of:
upon receiving the HTTP request resulted from the Internet user clicking on the hyper-link of the ad pointing back to this routine, extracting the ad identifier and article identifier from the URL parameters;
recording into the ad activity log the current time and one instance of the ad identifier and article identifier pair;
using the ad identifier to extract the ad hyper-link previously removed from the ad content and stored in the ad database in the ad submission process;
sending an HTTP redirect reply back to the Web browser of the Internet user with the ad hyper-link URL pointing to the Web site or shopping channel of the advertiser.

10. The method of claim 1, wherein (g) comprises the steps of:
(a) assigning zero to the royalty amount for each author identified by the author identifier;
(b) assigning zero to the ad cost amount for each advertiser identified by the advertiser identifier;
(c) retrieving one instance of the ad identifier and article identifier pair recorded within the current accounting period from the ad activity log;
(d) using the article identifier to extract the author identifier from the article database;
(e) using the ad identifier to extract the advertiser identifier and ad unit price from the ad database;
(f) adding the ad unit price to the ad cost amount identified by the advertiser identifier;
(g) adding the multiplication product of the ad unit price and a royalty rate to the royalty amount identified by the author identifier;
(h) repeating steps (c) to (h) for the next instance of the ad identifier and article identifier pair recorded within the current accounting period until all such instances are processed in the ad activity log;
(i) for each non-zero royalty amount, using the author identifier to extract the author billing information from the author database to pay the corresponding author;
(j) for each non-zero ad cost amount, using the advertiser identifier to extract the advertiser billing information from the advertiser database to bill the corresponding advertiser.

11. A method for conducting Internet-based online publishing and advertising forums in which authors are rewarded with a recurrent royalty drawn from the advertising revenue generated specifically by the articles they published through ads placed at run-time by third party advertising agents comprising:
(a) an author registration process of inputting the contact and billing information of a author and a new unique author identifier into to an author database; and repeating the same for other authors not previously registered;
(b) an article submission process of inputting the full content of an article, a new unique article identifier and the corresponding author identifier into to an article database; and repeating the same for other articles by the same or different registered author;
(c) an ad channel registration process of applying for an ad channel for each registered author from at least one third party advertising agent, converting the assigned ad channel into ad channel identifier applicable to the forum database system, and inputting the ad channel identifier and the corresponding author identifier into an ad channel database;
(d) a Web presentation process of displaying the information of and hyper-links to all available articles on an Internet Web site organized based on the subject matters of the articles, thus allowing Internet users to browse through and drill down to different categories and groups of articles and ultimately click on the hyper-link to an article to view its full content;
(e) an article delivery process of, upon the forum Web server receiving an HTTP request sent by the Web browser of an Internet user to access the full content of an available article, delivering a Web version of the article that includes reserved ad spaces for ads provided by third party ad agents;
(f) an accounting process of periodically receiving from at least one ad agent the ad revenue payment and an ad performance report detailing the total earnings of each ad channel, and paying authors whose articles contributed to the ad revenue of that period.

12. The method of claim 11, wherein (d) the hyper-link to an article includes the article identifier as a hyper-link URL parameter;

13. The method of claim 11, wherein (d) further comprises of providing a search engine function on the Web site to allow Internet users to search among all articles available on the forum for certain keyword(s), and displaying in a list the information of and hyper-links to the articles matching the search criteria.

14. The method of claim 13, wherein the hyper-link to an article matching the search criteria includes the article identifier as a hyper-link URL parameter.

15. The method of claim 11, wherein (e) comprises the steps of:
parsing the URL of the HTTP request for the article to extract the article identifier;
using the article identifier to extract the article content from the article database;
inserting the article content into a HTML Web article template with reserved ad spaces;
inserting the appropriate HTML code into the ad spaces as required by the ad agents;
transmitting the completed HTML Web article with reserved ad spaces to the Web browser of the Internet user.

16. The method of claim 11, wherein (f) further comprises the steps of:
(a) retrieving one ad channel and its corresponding total ad earning from the ad performance report and converting the ad channel to ad channel identifier applicable to the ad channel database;
(b) using the ad channel identifier to extract the author identifier from the ad channel database;
(c) calculating the royalty amount by multiplying the total ad earning by a royalty rate;
(d) using the author identifier to extract the author billing information to pay the corresponding author;
(e) repeating steps (a) to (e) for the next ad channel until all ad channels in the report are processed.

17. A system for conducting Internet-based online publishing and advertising forums in which authors are rewarded with a recurrent royalty drawn from the advertising revenue generated specifically by the articles they published comprising:
at least one server computer;
at least one database management system running on a server computer with minimum capabilities of storing a set of data along with a unique piece of data called the key or identifier, and
retrieving a set of data by matching its corresponding key with a supplied key;
at least one Web server program running on a server computer that provides at least one Web site;
an accounting program.

18. The system of claim 17, wherein the Web site comprises:
an author registration interface for new authors to enter their contact and billing information;
an article submission interface for registered authors to submit articles;
an advertiser registration interface for new advertisers to enter their contact and billing information;
an ad submission interface for registered advertisers to submit ads and ad preferences;
an article catalog interface consisting of a main category Web page, a plurality of sub-category Web pages of different subject matters, and a plurality of base category Web pages with information of and hyper-links to the full contents of available articles;
an article delivery program for receiving HTTP requests for the full content of an article and delivering a Web version of the article with inserted ads.

19. The system of claim 18, wherein the article delivery program is further capable of:
recording into the database ad performance data, including ad impressions and user clicks, and the association between an ad, the advertiser of the ad, the article in which the ad resides and the author of the article; or
inserting a piece of HTML code into the reserved ad spaces of the Web version of the article as required by a third party advertising agent to facilitate such agent to deliver ad content to the Web browser of the Internet user displaying the article.

20. The system of claim 17, wherein the accounting program is run in a regular interval to calculate:
the royalty due to each author and the total ad cost for each advertiser within that accounting period based on the recorded ad performance data, including ad impressions and user clicks, and the association between an ad, the ad pricing, the advertiser of the ad, the article in which the ad resides and the author of the article; or
the total amount of royalty due to each author within that accounting period based on the ad performance report from the third party ad agent detailing the total earnings of each ad channel, which corresponds to a registered author of the forum.
